(19) United States
(12) Patent Application Publication
(10) Pub. No.: US 2007/0058175 A1
(43) Pub. Date: Mar. 15, 2007

(54) Method and apparatus for 3-dimensional measurement of the surface of an object

(76) Inventor: Konrad Maierhofer, Nussdorf (DE)

Correspondence Address: KATTEN MUCHIN ROSENMAN LLP, 575 MADISON AVENUE, NEW YORK, NY, 10022-2585, US

(21) Appl. No.: 10/980,863

(22) Filed: Nov. 3, 2004

(30) Foreign Application Priority Data
Sep. 24, 2004 (EP) 04022762.1

(51) Int. Cl. G01B 11/24

(52) U.S. Cl. 356/601; 356/602

(57) ABSTRACT

In a method for 3-dimensional measurement of the surface of an object, the object is imaged 2-dimensionally, at a first focal distance of at least one CCD camera (3, 30), which can be swiveled in two directions and which is provided with an optical zoom function, and at least one point (P1, P2) to be measured is selected on the surface of the object, onto which point the laser beam (L) is directed. The optical axis of the at least one CCD camera (3, 30) is aligned in zoom mode at long focal distance toward the light spot generated by the laser beam. The coordinates of the selected point are ascertained by using the direction vectors, determined by appropriate rotary position sensors, of the laser beam and of the optical axis of a CCD camera or by using the direction vectors of the optical axes of two CCD cameras aligned toward the light spot.

The present invention relates to a method for 3-dimensional measurement of the surface of an object and to an apparatus suitable for performing this method.

Measurement of the 3-dimensional structure of components or other objects is frequently of great importance in the most diverse industrial applications.

In connection with quality control, for example, the components produced in many industrial production operations are examined as to their spatial extent or, in view of further processing or use, they are placed in spatially correct manner in a mold or other coordinate system. Further important aspects in many such applications are that high precision must be achieved in alignment of the object in question, or that particular points on the component must be marked. Without being construed as limitative, the following can be regarded as practical examples of such applications: alignment of glass-fiber or carbon-fiber mats in a production mold in aviation or automotive engineering; layering of resin-impregnated glass-fiber mats and aluminum-sheet sections in aviation engineering; fastening of built-on components to the hulls of ships or to the fuselages of aircraft or in cabins; marking of bores or cuts planned for a component; positioning, in spatially correct manner, of welded-on parts, built-in parts or formwork for prefabricated concrete components; arrangement of the beams of truss structures or other wood structures for roofs; and many others.

Besides the usual manual methods, such as stretching of alignment strings along scribe marks on the mold, measuring with tape measures and the use of templates, laser projection has already been used successfully for the foregoing purposes to mark appropriate points in a mold or on a component or object. In the process, a specified pattern, which may simply consist of individual points, is projected by means of a laser projector onto the mold for the object or onto the surface of the object, thus producing a kind of “template of light”.

Even in this case, however, it is usually indispensable that, before laser projection, the most accurate information possible already be obtained about the 3-dimensional shape of the surface of the object or merely about individual points thereof, together with information about its situation relative to the laser projector. This is not very problematic in the case of objects whose 3-dimensional extents are already known by virtue of a highly precise manufacturing operation. Their relative position and alignment relative to the laser projector can then be predetermined, for example by a correspondingly accurate support structure holding the object, so that all information is available that may be needed to mark, in spatially correct manner, particular points or zones with a pattern to be generated by the laser projector. In the case of CNC-machined components, for example, the information describing the shape of the component exactly can be derived directly from the CAD data generated for CNC machining. Considering the reference coordinate system predetermined by, for example, a support structure holding the object, the desired pattern can then be projected by means of a laser projector onto the component or the support structure provided for the component.

In many applications, however, such CAD data about the object in question do not exist or, because of a manual manufacturing operation or other reason, the support structure for the object or the exact spatial shape of the object is not adequately known. Appropriate laser projection is then not even possible or cannot be achieved with the necessary accuracy. In this case also, therefore, a need exists for a system capable of the most precise possible measurement of the 3-dimensional surface of objects. As a special practical example of such a system there can be cited the prior measurement of a support structure for an object, which structure may also comprise the surface of a work table, for example, followed by projection of a pattern onto the surface of this support structure.

The most diverse measuring methods and apparatuses are already known for 3-dimensional measurement of objects. Examples include coordinate measuring machines (CMM), photogrammetry or stereophotogrammetry, theodolites or other spatial measuring methods that depend, for example, on triangulation, laser radar, index arms, laser interferometry or combinations of the aforesaid methods or apparatuses.

In many cases, however, the methods and apparatuses known in the prior art prove to be too expensive for the given application or to be impractical, since they do not achieve the compromise necessary for the application in terms of measurement accuracy of the method, purchase and maintenance costs of the associated apparatus, system reliability, possible uses of the apparatus and user confidence.

As an example, a first method, based on triangulation, for 3-dimensional measurement of a surface is described in U.S. Pat. No. 5,661,667 A. Therein two laser beams directed from different directions onto the surface of an object are brought into coincidence on a reflector to be attached at the target point. Knowing the positions of the two laser projectors relative to a predetermined coordinate system, it is then possible to calculate the 3-dimensional coordinates of the reflector disposed on the surface from the measurable direction vectors of the two laser beams.

A further apparatus that permits determination of the 3-dimensional coordinates of points on the surface of a component is described in U.S. Pat. No. 5,615,013 A. Therein a laser beam generated by a laser projector is directed onto the surface of an object, and the light spot produced thereon is imaged in a camera system via a mirror system comprising two swivelable mirrors. From the relative arrangement of the system components, the direction vector of the laser beam and the respective deflection of the mirrors of the mirror system, it is then possible in turn to infer the exact position of the light spot on the component surface.

Finally, German Patent 4334060 A1 also describes a method and an apparatus for determining a spatial parameter of a target point. For this purpose, a laser beam scattered diffusely at the target point is detected at the center of a photosensitive detector, which center can be regarded as the reference point. This detector can be a PIN photodiode or quadrant diode, and a regulating mechanism for linear slaving of the source and photosensitive detector is provided for measuring deflections of the target point.

Starting from the already known prior art and the foregoing considerations, the object of the present invention is therefore to provide, for 3-dimensional measurement of the surface of objects, a method as well as an apparatus suitable for performing the method, which method and apparatus will prove to be as versatile in use and as inexpensive as possible while achieving the highest possible measurement accuracy.

This object is achieved by two methods, based on the same inventive idea, for 3-dimensional measurement of the surface of an object according to claims 1 and 2. Claim 1 describes a method of the class in question, comprising the following steps A1) to H1):
A1) 2-dimensional imaging of the object, at a first focal distance of a CCD camera, which can be swiveled in two directions and which is provided with an optical zoom function
B1) selecting at least one point to be measured on the surface of the object
C1) determining the direction vector of a laser beam directed with its center onto a point to be measured on the surface of the object
D1) detecting the light spot generated by the laser beam on the surface of the object by means of the CCD camera
E1) aligning, at a second focal distance longer than that used in step A1), the optical axis of the CCD camera toward the center of the light spot generated on the surface of the object
F1) determining the direction vector of the optical axis of the CCD camera
G1) calculating, within a reference coordinate system, the effective 3-dimensional coordinates of the point marked by the center of the light spot on the surface of the object from the two direction vectors of the laser beam and the optical axis of the CCD camera, allowing for the relative arrangement of CCD camera and laser projector
H1) repeating steps C1) to G1) for all points selected in step B1).

The second inventive method comprises the following steps A2) to H2):
A2) 2-dimensional imaging of the object, at first focal distances of respectively two CCD cameras, each of which can be swiveled in two directions and each of which is provided with an optical zoom function
B2) selecting at least one point to be measured on the surface of the object
C2) aligning a laser beam with its center toward a point to be measured on the surface of the object
D2) detecting the light spot generated by the laser beam on the surface of the object by means of both CCD cameras
E2) aligning, at respective second focal distances longer than those used in step A2), the optical axis of both CCD cameras toward the center of the light spot generated on the surface of the object
F2) determining the direction vectors of the optical axes of both CCD cameras
G2) calculating, within a reference coordinate system, the effective 3-dimensional coordinates of the point marked by the center of the light spot on the surface of the object from the two direction vectors of the optical axes of the CCD cameras, allowing for the relative arrangement of the two CCD cameras
H2) repeating steps C2) to G2) for all points selected in step B2)

The difference between the two methods lies essentially in the fact that, for measurement of the coordinates of a light spot projected by a laser projector onto the surface of the object in the first case, the direction vector of the laser beam emitted by the laser projector is used together with the direction vector of the optical axis of a CCD camera aligned exactly toward the light spot, whereas in the second case the laser projector is used merely to project a light spot onto the surface of the object, where the two direction vectors of two CCD cameras aligned exactly toward the light spot are used to measure the coordinates of the light spot.

In both of the foregoing methods, the possibility—which does not exist in the cited documents—of first viewing the entire component 2-dimensionally with at least one CCD camera at a first focal distance already proves to be extremely advantageous. The 2-dimensional imaging of the object to be measured can subsequently be used advantageously to select points to be measured more accurately by means of the laser projector. In addition, these images can also be stored advantageously for documentation purposes in a data-processing system or in a computer system.

A further major advantage lies in the provision and use of the at least one CCD camera equipped with variable optical zoom. This permits for the first time the at least two-stage performance of the two independent methods, in which a first focal distance is adjusted in a first stage for imaging the object (for example, in a wide-angle snapshot), after which a second and longer focal distance is used in a second stage for measurement of the object with greater measuring accuracy. Thereby, by means of the optical zoom, it is additionally possible to adapt the measuring accuracy for detection of the light spot with the CCD camera variably according to the existing conditions (for example, the size of the light spot of the laser beam scattered diffusely at the surface of the object; or the respective distance between the CCD camera and the object). In particular, diverse types of components can also be measured in their spatial extent in this way, by the fact that the optical zoom can be adapted to the respective conditions.

In particular, in the measurement of different target points of a component, it can also be advantageously provided that the second focal distance is separately adjustable or is adjusted for each point to be measured. This can be used, for example, to adapt the size of the light spot imaged on the CCD chip of the camera. If the focal distance were fixed, this size would otherwise vary as a function of the respective scattering power or reflectivity of the target point and of the respective distance between the CCD camera and the target point.

In particular, not the least aspect of the use of a variable optical zoom in the inventive method is that there is no need to use retroreflectors on the surface of an object. Moreover, objects of different reflecting power can also be measured in this way, by the fact that a different size of the light spot generated on the respective surface of the object by diffuse scattering of the laser beam can be compensated by variation of the optical zoom. The inventive method thus proves to be more versatile in use than the known prior art.

Above and beyond this, a further advantage of the inventive method is that the measurement accuracy of the system suitable for performing the method in combination with the optical zoom is predetermined definitively by the particularly precise possible determination of the direction vector of the optical axis of the camera directed onto the light spot. This is true especially for the second inventive method, in which the direction vectors of two CCD cameras aligned toward the light spot are used for calculation of the coordinates. In the case of the first method, in which only one CCD camera is used, this is nevertheless equally true if the laser projector can be guided with sufficient accuracy. This is accomplished directly by the design of the two drive units of the swivelable CCD camera(s) and of the associated device(s) for determining the direction vector of the optical axis of the CCD camera, as will be discussed in greater depth hereinafter during the explanation of the apparatus.

In addition, the existing optical zoom advantageously permits comparatively high automation of the inventive method, in that, for example, the position of a light spot generated by reflection/scattering of the laser beam on the surface can first be detected automatically at a shorter focal distance, after which optimal imaging of the light spot on the CCD chip of the respective CCD camera can be achieved by subsequent slaving of the optical axis of the CCD camera(s) in combination with lengthening of the focal distance, in successive steps if necessary. By optimal imaging in this sense there is to be advantageously understood the imaging of the light spot in a certain size at the point of passage of the optical axis through the CCD chip, whereby adequately good detection of the light spot as well as its centering can be ensured. By alignment of the optical axis of a CCD camera toward the center of the light spot there is to be understood an alignment of the CCD camera whereby the center of the light spot is imaged on that pixel of the CCD chip of the CCD camera which is positioned at the point of passage of the optical axis, or on a plurality of such pixels disposed for this purpose around the point of passage of the optical axis, which pixel or pixels advantageously form exactly the center of the chip.

The center of the light spot can then be determined automatically from the spatial distribution of the light spot on the CCD chip. In particular, it can also be provided that the intensity profile of the light spot as described by a particular distribution function is used for this purpose. In the case of a large geometric deviation of the light spot from a round, elliptical or at least symmetric cross section, it can be provided that the respective determination of the center of a light spot can also be achieved manually, for example on an image, displayed on a monitor of a data-processing system, of the segment of the component surface observed by the respective CCD camera. This also proves to be advantageous in particular if, for example, because of step-like discontinuity of the surface, two light spots generated by a split beam are actually imaged by a laser beam. In this case, an error message indicating this circumstance to the user could also be provided advantageously, prompting him to define a new target point, for example, at which the center of a light spot can once again be determined automatically.

The slaving of the optical axis of the CCD camera(s) to the center of the light spot as provided in the inventive method leads, in combination with the variable optical zoom, to a further major advantage of the method and of the associated apparatus. This lies in the fact that neither the quality nor the resolution of the camera(s) being used must meet particularly stringent requirements since, as already mentioned hereinabove, the measuring accuracy of the system is predetermined definitively by the positioning accuracy of the CCD camera(s) or the readout accuracy for the respective direction vector of the optical axis of a CCD camera. In the present case, therefore, it is already possible to work with, for example, CCD cameras having the conventional resolution of the PAL or NTSC television standard (up to 768×567 or 640×480 pixels). On the one hand, this ensures that the overall image obtained of the component in step A1) or A2) is still of acceptable quality. On the other hand, it is completely adequate for detection of the light spot on the surface at the longer focal distance. Particularly as regards the costs of purchase or manufacture of apparatus suitable for this method, this proves to be extremely favorable, since such cameras, especially those also equipped with a zoom function, can be manufactured or purchased at comparatively favorable prices. In contrast, in other common prior art methods, the measuring accuracy of the associated system frequently depends directly on the resolution of a camera system being used.

According to a first advantageous configuration of the inventive method, it can be provided that, by means of a computer system, the image(s) to be generated in step A1) or A2) is or are composed of a plurality, preferably fewer than ten, individual snapshots of the CCD camera, each representing only one part of the object. This proves to be advantageous in particular if the object according to the invention is one with large spatial extent, for example of several meters in each direction. On the one hand, a 2-dimensional image of adequate quality can again be obtained of the object in this way, despite the use of a low-resolution camera. On the other hand, this can also be practical if a CCD camera being used is unable to view the entire object at its shortest focal distance, so that several snapshots are necessary for this purpose. The individual snapshots are then preferably composed automatically by the connected computer system.

In addition, it can be provided that the selection, described in step B1) or B2), of the points to be measured is accomplished by aligning the laser beam of the laser projector toward the respective point to be measured. For this purpose, the laser projector is advantageously controlled by means of the computer system. Also advantageously, the laser beam directed onto the surface of the object is observed, preferably in real time, by means of the image of the object displayed by a CCD camera, and it can be controlled via an input device connected to the computer system, for example a keyboard, mouse, joystick, etc.

In a further advantageous embodiment of the inventive method, it is provided that the selection described in step B1) or B2) is accomplished automatically by a computer system. This proves to be advantageous in particular for quality control of objects whose dimensions are largely known and which are retained in an appropriate holder. In this case it can be provided in particular that the most diverse points or profiles on the component surface are selected at random in the manner of spot checks, or that a certain number of predetermined points is automatically selected for each component by the computer system.

In yet another advantageous embodiment of the inventive method, it can be further provided that the points to be selected in step B1) or B2) form an automatically generated grid pattern within a zone of the surface of the object to be selected by the user. As an example of how this can be achieved, the user first directs the laser beam of the laser projector onto four points of the surface of the component forming the corners of a zone, thus defining the zone to be selected by him. The desired resolution of the grid pattern to be generated by the computer in this zone can then also be predetermined by the user or already preset in the computer system as a function of the special application and desired resolution.

In yet another advantageous configuration of the inventive method, the automatic detection, described in step D1) or D2), of the light spot on the surface of the object is accomplished by means of a difference image, which is calculated from two individual snapshots of a CCD camera, one with the laser beam turned on and the other with the laser beam turned off. For otherwise constant illumination, it is then an easy matter for an appropriately programmed computer system directly to detect the light spot generated by the laser beam on the difference image of this type. Other methods would also be conceivable, such as detection of the light spot by means of its color, or in other words that wavelength of the emitted light beam which is characteristic of the laser projector. In particular, a combination of this method with the aforesaid difference-image calculation seems advantageous.

For determination of the direction vector of the laser beam according to step C1) or C2), for determination of the direction vector of the optical axis of the CCD camera according to step F1) or F2), and/or for calculation of the coordinates of a point on the surface of the object according to step G1) or G2), it is also advantageous to provide the inventive method with software compensation for elimination of known measurement deviations. Such measurement deviations can be, for example, known imaging defects of the optical system, known uncertainties of the two devices for determination of the exact direction vectors of the incident laser beam and the optical axis of the CCD camera, pixel defects of the CCD chip of the CCD camera, or other known constant measurement deviations, which are advantageously determined in an appropriate calibration of the apparatus.

Moreover, it is extremely advantageous if, after 3-dimensional measurement of the selected points of the surface of the object, a predetermined pattern can be projected with the laser projector onto the surface of the object in a further step of the method, for example as an optical template for objects to be disposed within the said pattern. In this way the two inventive methods and an apparatus suitable for performing one of these methods in the manner according to the invention prove to be extremely versatile and flexible, because of the fact that both a measurement of the surface of an object and subsequent marking of specified points or patterns by means of the laser beam on the surface of the object is made possible with an apparatus having only one laser projector. Above and beyond this, it can be advantageously provided that corresponding patterns to be projected onto the surface in a snapshot of the object generated in step A1) or A2) can be selected by means of the computer system or plotted therein.

Furthermore, it is advantageous if, in a further step of the method, the orientation of a known pattern on the surface of the object is calculated from an image of the object generated by the CCD camera. Depending on the size of the object and of the pattern, either an image of the entire object generated in step A1) or step A2) or a detail snapshot of part of the object or component generated in a further step of the method can be used for this purpose. This is extremely advantageous in, for example, measurement of carbon-fiber mats or glass-fiber mats, since in this way it is possible to determine the alignment of the fibers characteristic of a corresponding mat and manifested in a special pattern of the surface.

Furthermore, it can be advantageously provided in another step of the method that the arrangement of an object of known dimensions is calculated from the coordinates of the measured points. Herewith the inventive method can also be used to determine the situation and orientation of an object with known dimensions, for example by determining the absolute positions of specified points (such as corners, edges, bores, etc.) of the surface of the object, the relative coordinates of such points being known from data such as CAD data of the object.

It is then further advantageous if the arrangement of the object calculated according to one or both of the two aforesaid steps of the method or the alignment of a specified pattern toward the surface of the object is subsequently compared with a predeterminable index value. Thereby it is possible, for the purposes of production or quality control, for example, to check whether carbon-fiber mats are situated with the correct orientation, since they are frequently arranged in different layers with a specified sequence of orientation angles, or to check whether specified components are situated in correct position and properly aligned prior to a further manufacturing step. For this purpose it further proves favorable if an electrical, acoustic and/or optical signal is initiated if the alignment of the object or of the pattern on the surface of the object is not in conformity with the index value or range of index values. In the event of defective situation or alignment of a particular object or component, a device or a mechanism designed, for example, to stop a production belt, can be additionally provided.

As already mentioned in the foregoing, also regarded as inventive is an apparatus suitable for performing one of the two aforesaid methods for 3-dimensional measurement of the surface of an object, the apparatus comprising a holder for the object, a laser projector, at least one CCD camera and a computer system in communication with the relevant components of the apparatus for recording and evaluation of the obtained data, the laser projector being provided with a device for determining and/or controlling the direction vector of a laser beam that it directs onto the surface of the object, and the at least one CCD camera being equipped with a variably adjustable optical zoom function, being capable of being aligned toward the surface of the object by being swiveled in two different directions by means of two drive units, and being provided with a device for determining the direction vector of its optical axis.

The components with which the apparatus is provided according to the invention as well as their effects distinguishing them advantageously from the prior art have already been adequately evaluated in the description of the inventive method, and so no further repetition of these advantages is needed at this place.

In a first advantageous configuration of the inventive apparatus, it is provided that the two drive units of the at least one CCD camera each have a worm gear and a rotary position transducer connected to the worm shaft. In this way adequate and extremely precise swiveling capability of the CCD camera is achieved for the intended areas of application of the apparatus. Specifically, the direction vector of the optical axis is then determined by reading out the rotary position sensor after appropriate calibration of the system. Advantageously both worm gears are pretensioned to eliminate play, thus further improving the guidance of the CCD camera, which in any case was already precise. Such pretensioning of the worm gears is advantageously achieved by means of a spiral spring acting on the respective worm wheel.

By skillful selection of the reduction ratio of the worm gear, of the number of pulses of the rotary position transducer per revolution and of the maximum possible swiveling range of the CCD camera along both directions, it can be advantageously ensured that the angular resolution of the device for determination of the direction vector of the optical axis of the camera is better than 10 seconds of angle, advantageously better than 5 seconds of angle and even more advantageously better than 3 seconds of angle. In this connection, it must be pointed out once again that this accuracy contributes definitively to the achievable resolution of the overall system during determination of the direction vector of the optical axis of the camera, and that such resolution is not or only slightly contingent upon the number of pixels of the CCD chip of the CCD camera.

As an example, the resolution cited in the foregoing can be achieved by using a camera with a maximum possible swiveling range of 100° (see hereinafter), a worm gear with a reduction ratio of 100:1 and a rotary position transducer with a resolution of 5000 steps per revolution. In this way a resolution of (100/360)*100*5000=138888 steps over the entire observation range of 100°, thus corresponding to an angular resolution of (100°/138888)*3600=2.59 seconds of angle.

A contributing factor for the possible measuring accuracy of the overall apparatus, however, is obviously also the accuracy of guidance of the laser projector (or of determination of the direction vector of the emitted laser beam). For this reason, ideally a laser projector having a resolution on the order of magnitude of the aforesaid resolution for determining the direction vector of the optical axis of the CCD camera should be chosen.

The maximum possible focal distance of the optical zoom function of the CCD camera is then advantageously chosen such that it permits at least 10× magnification, advantageously at least 15× magnification and even more advantageously 20× magnification. With these maximum focal distances it is possible to ensure adequate enlargement of a light spot scattered on the component surface, and so even the use of a commercial CCD camera with a resolution corresponding to the television standard achieves adequate precision for detection of the light spot imaged at the center of the chip. However, the maximum possible speed of readout of the pixels of the CCD chip is obviously of importance in particular, in order to ensure that the method runs as quickly as possible. To this extent, therefore, the fact that the invention permits the use of CCD cameras with comparatively low resolution is also specially advantageous from the viewpoint that a small number of pixels on the CCD chip can naturally be read out more quickly than would be the case in a high-resolution camera.

The maximum possible swiveling range of both drive units of the CCD camera from stop to stop advantageously includes an angular range of at least 80°, and even more advantageously of 100°. Thus, even if the camera is disposed in direct proximity to an object, the extremely broad swiveling range ensures adequate coverage of the image area for many common applications.

The laser projector advantageously comprises two rotatable, magnetically guidable mirrors, which ensure deflection of the laser beam generated in the laser projector onto the surface of the object to be measured.

The performance of a practical example of the first inventive method and two practical examples of the inventive apparatus will be explained in more detail hereinafter by means of the drawing, wherein

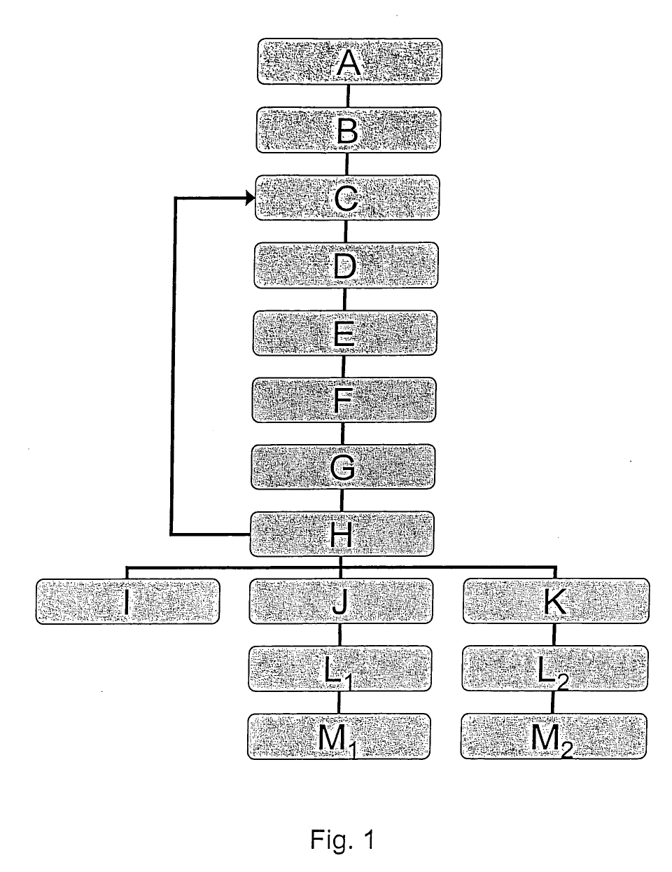

FIG. 1 shows a flow diagram of the performance of a practical example of the inventive method,

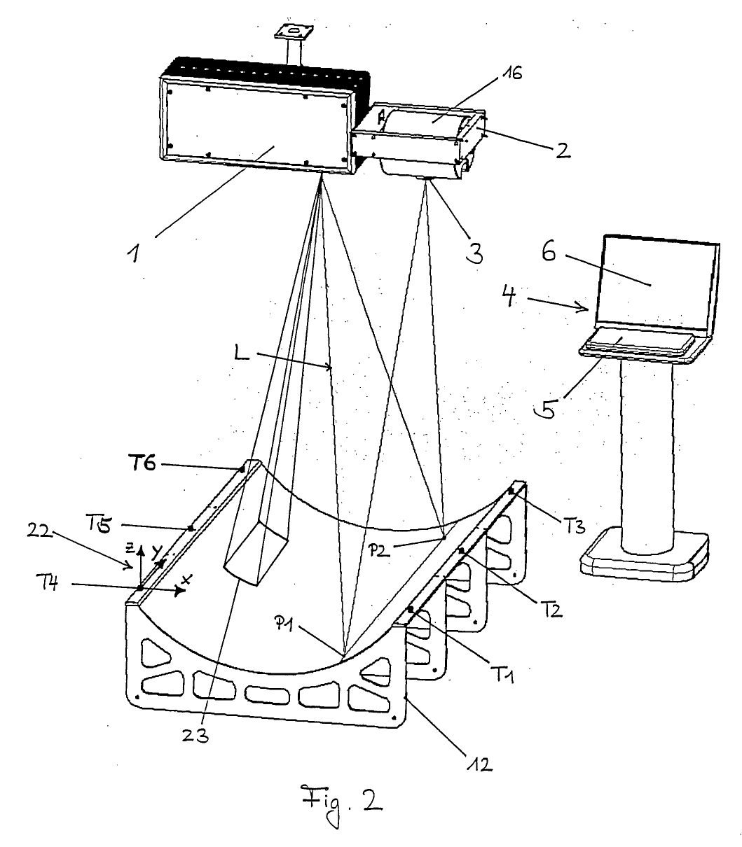

FIG. 2 shows a diagram of a first practical example of the inventive apparatus,

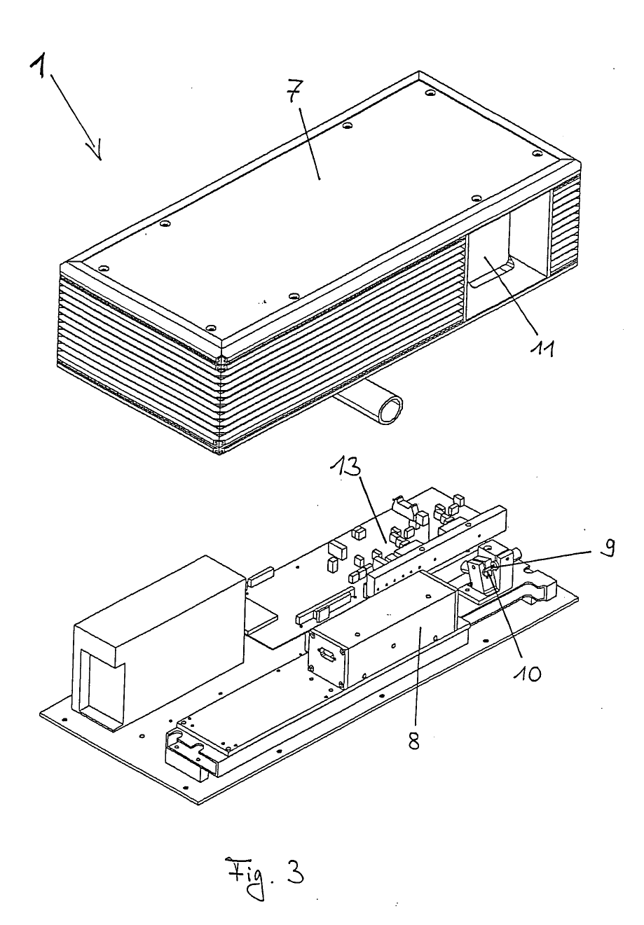

FIG. 3 shows the structure of the laser projector of the practical example according to FIG. 2,

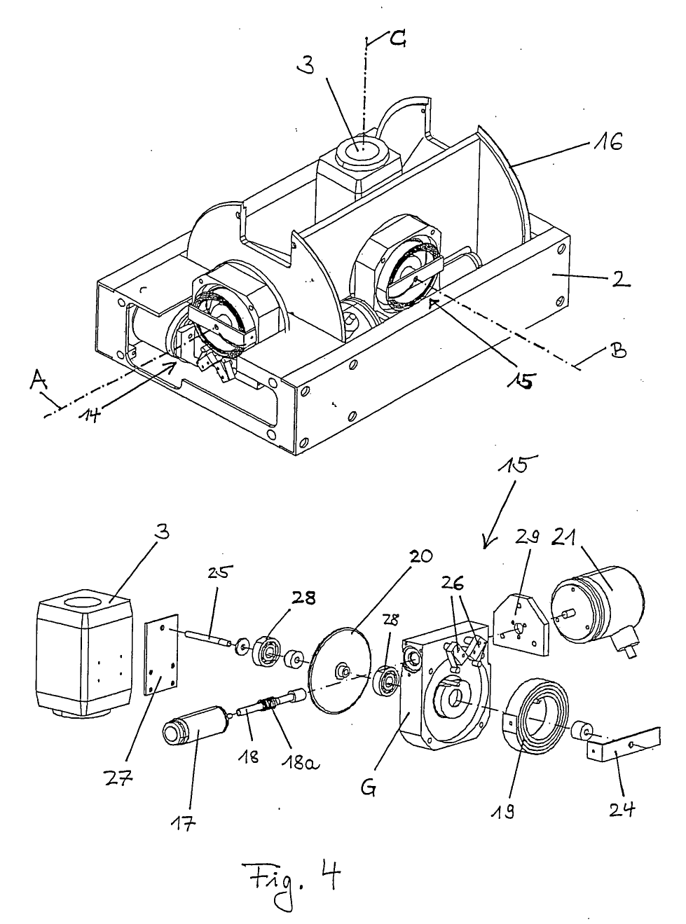

FIG. 4 shows a detail view of the CCD camera of the practical example according to FIG. 2 in its mounting equipped with two drive units for swiveling the CCD camera; it also shows a further detailed diagram of one of the two drive units, and

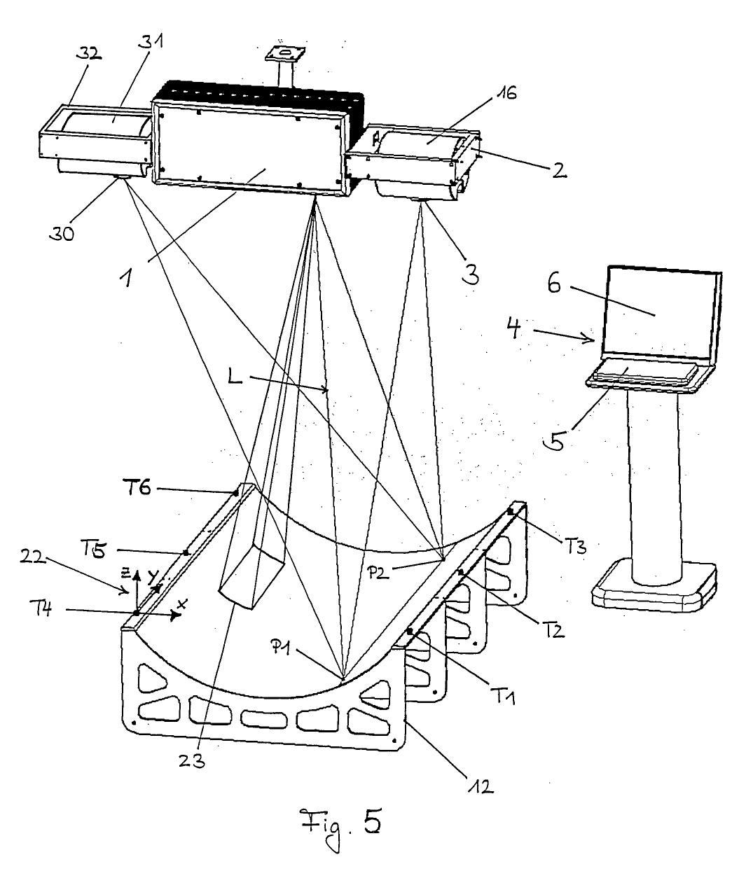

FIG. 5 shows a diagram of a second practical example of an apparatus according to the invention.

FIG. 1 shows a flow diagram of the performance of an inventive method for 3-dimensional measurement of the surface of an object, comprising method steps A to M, the performance of which will be described hereinafter together with the explanation of the practical example of the apparatus.

The practical example of an inventive apparatus illustrated in FIGS. 2 to 4 is provided with a laser projector 1, a CCD camera 3 installed in a mount 2 that allows it to swivel in two directions, and a computer system 4, which is equipped with a keyboard 5 as the input device and with a monitor 6 as the output device. Obviously, however, further input devices such as a computer mouse or the like can also be provided, but they are omitted from the diagram for reasons of clarity. Computer system 4 is also in communication via connecting means, which also are not shown, with all relevant apparatus components and, by virtue of appropriate system components, is capable of controlling and reading out those components.

Laser projector 1, illustrated in detail in FIG. 3 with its housing 7 raised, is equipped with a laser system 8 (hereinafter also referred to as the laser) and with a mirror system comprising two magnetically deflectable mirrors 9, 10. By means of this mirror system, a laser beam emitted by laser 8 can be directed through exit aperture 11 of housing 7 of laser projector 1 onto the surface of an object 12 facing laser projector 1. By means of an appropriate electronic unit 13 of laser projector 1, it is possible on the one hand to predetermine a specified mirror position for both mirrors 9, 10 of the mirror system and on the other hand to read out the instantaneous position of the two mirrors 9, 10. From those readings, the direction vector of the laser beam emitted from laser projector 1 can be determined. The laser projector has a theoretical angular resolution of 80°/2ˆ16. Since such laser projectors are known in themselves, a detailed explanation is not necessary.

FIG. 4 shows, in a first diagram (top), mounting 2, in which CCD camera 3 and the two associated drive units 14, 15 are disposed. This CCD camera 3, equipped with a variable optical zoom (from wide-angle up to 20× magnification), is disposed together with second drive unit 15 in a drum 16 supported rotatably inside mounting 2. By means of first drive unit 14, drum 16 can be turned through a total angular range of 100° (from −50° to +50° relative to the illustrated position) around a first axis A. Inside rotatable drum 16, this CCD camera 3 is supported by means of second drive unit 15 in such a way that it can turn or swivel around a second axis B, which is turned by 90° relative to first axis A. Once again, a maximum swiveling range of 100° (from −50° to +50° relative to the illustrated position) is possible. The two drive units 14, 15 are of almost identical construction. In a second diagram in FIG. 4 (bottom), drive unit 15 for CCD camera 3 is shown in more detail in an exploded drawing, where it can be more readily understood. Thus drive unit 15 is provided with a motor 17 flanged onto a gear block G and with a worm gear having a reduction ratio of 100:1, which gear comprises worm shaft 18 driven by motor 17 and a worm wheel 20 pretensioned at one end relative to worm 18a by means of a spiral spring 19. In order to achieve this pretensioning, spiral spring 19 at its radially inner end is firmly joined to gear block G and at its radially outer end is firmly joined to a bracket 24, which in turn is joined via axial rod 25 to worm wheel 20. Gear block G is also provided with two limit switches 26, which are used as the stop for bracket 24 and with which the maximum possible swiveling range of CCD camera 3 can be predetermined. CCD camera 3 is joined by means of a mounting plate 27 to axial rod 25 of drive unit 15. Two ball bearings 28 additionally ensure that worm wheel 20 is guided exactly on both sides. Above and beyond this, the current position of worm shaft 18 can be read out with a resolution of 5000 steps per revolution by means of a rotary position transducer 21, which is fastened with a further mounting plate 29 to gear block G. In this way the direction vector of optical axis C of CCD camera 3 is determined from the number of complete revolutions of worm shaft 18 relative to a zero position and from the current angular position of worm shaft 18. Second drive unit 14 is of almost identical construction and is joined to drum 16 by means of a corresponding mounting plate.

As object 12 whose surface is to be measured by means of the inventive apparatus according to the practical example of the inventive method there is shown, in the practical example of the apparatus illustrated in FIG. 2, a support structure for a component (not illustrated) to be subsequently placed therein. Let it be assumed for this object 12 that the relative spacings between reference points T1 to T6 suitable for calibration of the system are indeed known, but that the geometry of the remaining surface facing laser projector 1 is not known.

The measurement of the 3-dimensional surface of object 12 with the inventive apparatus illustrated in FIGS. 2 to 4 will now be explained on the basis of a determination of the 3-dimensional coordinates of two points P1, P2 located on the surface of object 12.

For this purpose, CCD camera 3 is first aligned toward object 12, and object 12 is imaged in a wide-angle mode of camera 3 (step A, see FIG. 1). A corresponding image of this object 12 can be stored for documentation purposes in a memory of computer system 4.

By means of computer system 4, laser beam L generated by laser projector 1 is then directed first onto a point P1 and subsequently onto a point P2 of the surface of object 12. For this purpose, laser projector 1 is advantageously controlled by simultaneous observation of a real-time image of a segment of object 12 generated by CCD camera 3 and displayed on monitor 6 of computer system 4.

The position of the mirror system of laser projector 1 corresponding to the respective points P1 and P2 can then be stored in the computer system for the purpose of selection of the two points P1 and P2 on the surface of object 12 (step B, see FIG. 1).

In the automated steps of the method following completion of the selection of points P1, P2 on the surface of object 12, laser beam L of laser projector 1 is then directed first onto first point P1 to be measured, and the exact direction vector of this beam is determined by the computer system (step C, see FIG. 1). Then object 12 is imaged once again by means of CCD camera 3, and another snapshot of object 12 is taken by CCD camera 3 after laser 8 has been turned off. Therefore, from the difference image that can be calculated by the computer system with appropriate software, the position of the light spot generated by laser beam L at point P1 can be directly determined, also automatically, on the image segment illustrated by CCD camera 3 (step D, see FIG. 1).

Optical axis C of CCD camera 3 is then swiveled by means of the two drive units 14, 15 onto the center of the light spot, and the CCD chip of CCD camera 3 is read out once again at longer focal distance. By means of appropriate software, the computer system checks whether the center of the light spot is now imaged exactly on the point of passage of the optical axis of CCD camera 3 through the CCD chip. Any deviation from this that may still exist can be eliminated by renewed slaving of optical axis C of CCD camera 3 to the center of the light spot, which is now displayed at higher magnification. For this purpose, the focal distance is ideally adjusted in such a way that optimal imaging of the light spot on the CCD chip of CCD camera 3 takes place around that pixel of the CCD chip which is located on the point of passage of optical axis C. In this way, optical axis C of CCD camera 3 has been aligned toward the center of the light spot (step E, see FIG. 1).

After rotary position transducer 21 of the two drive units 14, 15 of CCD camera 3 has been read out, the direction vector of optical axis C of CCD camera 3 is then determined (step F, see FIG. 1).

On the basis of simple geometric considerations and of a reference coordinate system 22, which is known or can be determined, which in this case can be defined, for example, by measurement of the respective direction vectors to reference points T1 to T6 of the support structure, relative coordinates of which points are known (or by measurement of merely some of the points suitable for calibration and determination of reference coordinate system 22), and which in the present case has its origin at point T4, for example, the 3-dimensional coordinates of point P1 within reference-coordinate system 22 can therefore be calculated from the direction vectors of optical axis C of the camera and from the direction vector of laser beam L (step G, see FIG. 1). Alternatively, however, a calibration shape whose relevant extents are known can also be used for calibration of the system. In this operation, software compensation can be provided for elimination of known measurement deviations identified by calibration, such as a defect of a worm gear, for example in the form of unbalance on worm 18a of worm shaft 18.

After calculation of the coordinates of point P1, steps C to G are performed once again in order to measure second point P2 to be measured (step H, see FIG. 1).

The same method can then be performed on a plurality of points on the surface of object 12 facing laser projector 1. In this way a grid-like 3-dimensional model of the surface of object 12 facing laser projector 1 can be calculated, especially if the surface is represented by an appropriately fine-meshed grid.

Then, if a pattern 23 marking the intended orientation of a component to be disposed in a holder is to be projected subsequently onto the surface of object 12 (step I, see FIG. 1), for example to facilitate subsequent joining of a plurality of components together, it can first be plotted in the 3-dimensional model of the surface of object 12 calculated from the measurement, for example by means of computer system 4 and appropriate software. From this, the direction vectors necessary for projection of the laser beam used for projection can be determined. Laser projector 1 can be guided directly by computer system 4 for projection of predetermined pattern 23 on object 12.

During or after measurement of individual points or zones of the surface of the object, the orientation of a known pattern present on the surface of object 12 can be detected by means of computer system 4 via evaluation of the images taken by the CCD camera (step J, see FIG. 1). It can then be compared with a predeterminable index value (step L₁, see FIG. 1), and any alignment of the pattern that may not be in conformity with the index value can be appropriately signaled (step M₁, see FIG. 1).

The same applies for determination of the situation and alignment of an object 12 of known dimensions (step K, see FIG. 1), comparison with an index value provided for the purpose (step L₂, see FIG. 1) and any signaling that may be necessary if the arrangement of object 12 in question is not in conformity with the index value (step M₂, see FIG. 1).

Obviously almost all of the aforesaid embodiments are also applicable for the second practical example of an inventive apparatus, which is illustrated in FIG. 5 and is suitable for performing the second inventive method according to claim 2. This practical example differs from the practical example illustrated in FIG. 2 essentially by the presence of a second CCD camera 30 which, just as the first CCD camera 3, is disposed inside a drum 31 in a mounting 32 and is suspended by means of two drive units in such a way that it can be swiveled in two directions.

For determination of the 3-dimensional coordinates of a point P1, P2, in the method that can be performed with this apparatus, a light spot is then again generated at the said point P1, P2 by means of the laser projector. The coordinates of this spot are calculated from the two direction vectors of the optical axes of two CCD cameras 3, 30 aligned exactly toward light spot P1, P2. To this extent, the laser projector does not have to be equipped with a device for determination of the laser beam emitted by it; merely a device for control of the laser beam is needed. The method that can be performed with this apparatus can also be explained with the flow diagram of FIG. 1, with the exception that the steps of the method according to claim 2 are to be performed instead of the steps described in the first practical example.

1. A method for 3-dimensional measurement of the surface of an object, comprising the following steps:
A1) 2-dimensional imaging of the object, at a first focal distance of a CCD camera, which can be swiveled in two directions and which is provided with an optical zoom function
B1) selecting at least one point to be measured on the surface of the object
C1) determining the direction vector of a laser beam directed with its center onto a point to be measured on the surface of the object
D1) detecting the light spot generated by the laser beam on the surface of the object by means of the CCD camera
E1) aligning, at a second focal distance longer than that used in step A), the optical axis of the CCD camera toward the center of the light spot generated on the surface of the object
F1) determining the direction vector of the optical axis of the CCD camera
G1) calculating, within a reference coordinate system, the effective 3-dimensional coordinates of the point marked by the center of the light spot on the surface of the object from the two direction vectors of the laser beam and the optical axis of the CCD camera, allowing for the relative arrangement of CCD camera and laser projector
H1) repeating steps C1) to G1) for all points selected in step B1).

2. A method for 3-dimensional measurement of the surface of an object, comprising the following steps:
A2) 2-dimensional imaging of the object, at first focal distances of respectively two CCD cameras, each of which can be swiveled in two directions and each of which is provided with an optical zoom function
B2) selecting at least one point to be measured on the surface of the object
C2) aligning a laser beam with its center toward a point to be measured on the surface of the object
D2) detecting the light spot generated by the laser beam on the surface of the object by means of both CCD cameras
E2) aligning, at respective second focal distances longer than those used in step A2), the optical axis of both CCD cameras toward the center of the light spot generated on the surface of the object
F2) determining the direction vectors of the optical axes of both CCD cameras
G2) calculating, within a reference coordinate system, the effective 3-dimensional coordinates of the point marked by the center of the light spot on the surface of the object from the two direction vectors of the optical axes of the CCD cameras, allowing for the relative arrangement of the two CCD cameras
H2) repeating steps C2) to G2) for all points selected in step B2)

3. A method according to claim 1 characterized in that,
by means of a computer system, the image(s) to be generated in step A1) or A2) is or are composed of a plurality of individual snapshots of the at least one CCD camera, each representing only one part of the object.

4. A method according to claim 1, characterized in that
the selection, described in step B1) or B2), of the points to be measured is accomplished by aligning the laser beam of the laser projector toward the respective point.

5. A method according to claim 1, characterized in that
the selection described in step B1) or B2) is accomplished automatically by a computer system.

6. A method according to claim 1, characterized in that
the points to be selected in step B1) or B2) form an automatically generated grid pattern within a zone of the surface of the object to be selected by the user.

7. A method according to claim 1, characterized in that
the automatic detection, taking place in step D1) or D2), of the light spot on the surface of the object is accomplished by means of a difference image, which is calculated from two individual snapshots of the at least one CCD camera, one with the laser beam turned on and the other with the laser beam turned off.

8. A method according to claim 1, characterized in that,
for determination of the direction vector of the laser beam according to step C1), for determination of the direction vector of the optical axis of the at least one CCD camera according to step F1) or F2), and/or for calculation of the coordinates of a point on the surface of the object according to step G1) or G2), there is provided software compensation for elimination of known measurement deviations.

9. A method according to claim 1, characterized in that,
after 3-dimensional measurement of the selected points of the surface of the object, a predeterminable pattern is projected with the laser projector onto the surface of the object.

10. A method according to claim 1, characterized in that
the orientation of a known pattern on the surface of the object is calculated from an image of the object generated by a CCD camera.

11. A method according to claim 1, characterized in that
the arrangement of an object of known dimensions is calculated from the coordinates of the measured points.

12. A method according to claim 10, characterized in that
the calculated arrangement of the object or the alignment of the pattern on the surface of the object is compared with a predeterminable index value.

13. A method according to claim 12, characterized in that
an electrical, acoustic and/or optical signal is initiated if the alignment of the object or of the pattern on the surface of the object is not in conformity with the index value.

14. An apparatus suitable for performing a method according to claim 1 for 3-dimensional measurement of the surface of an object, the apparatus comprising a support structure for the object, a laser projector, at least one CCD camera and a computer system in communication with the relevant components of the apparatus for recording and evaluation of the obtained data, the laser projector being provided with a device for determining and/or controlling the direction vector of a laser beam that it directs onto the surface of the object, and the at least one CCD camera being equipped with a variably adjustable optical zoom function, being capable of being aligned toward the surface of the object by being swiveled in two different directions by means of two drive units, and being provided with a device for determining the direction vector of its optical axis.

15. An apparatus according to claim 14, characterized in that
the two drive units of the at least one CCD camera each have a worm gear and a rotary position transducer connected to the worm shaft.

16. An apparatus according to claim 15, characterized in that
both worm gears are pretensioned to eliminate play.

17. An apparatus according to claim 16, characterized in that
the pretensioning of the worm gears is achieved by means of a spiral spring.

18. An apparatus according to claim 14, characterized in that
the angular resolution of the device for determination of the direction vector of the optical axis of the at least one CCD camera is better than 10 seconds of angle, advantageously better than 5 seconds of angle and even more advantageously better than 3 seconds of angle.

19. An apparatus according to claim 14, characterized in that
the maximum focal distance of the optical zoom function of the at least one CCD camera permits at least 10× magnification, advantageously at least 15× magnification and even more advantageously 20× magnification.

20. An apparatus according to claim 14, characterized in that
the maximum possible swiveling range of both drive units of the at least one CCD camera from stop to stop includes an angular range of at least 80°, advantageously of 100°.

21. An apparatus according to claim 14, characterized in that
the laser projector comprises two rotatable, magnetically guidable mirrors
